(19) United States
(12) Patent Application Publication
(10) Pub. No.: US 2025/0362678 A1
(43) Pub. Date: Nov. 27, 2025

(54) METHOD FOR AT LEAST PARTIALLY AUTONOMOUSLY DRIVING A MOTOR VEHICLE AS WELL AS MOTOR VEHICLE

(71) Applicants: CARIAD SE, Wolfsburg (DE); Robert Bosch GmbH, Stuttgart (DE)

(72) Inventors: Daniel Bauer, Wolfsburg (DE); Hauke Brunken, Wolfsburg (DE); Wolfgang Steiner, Wolfsburg (DE); Alexander Mann, Wolfsburg (DE)

(21) Appl. No.: 19/216,392

(22) Filed: May 22, 2025

(30) Foreign Application Priority Data
May 24, 2024 (DE) 10 2024 114 652.4

(51) Int. Cl. G05D 1/2285; G05D 109/10; G06F 40/40

(52) U.S. Cl. CPC G05D 1/2285; G06F 40/40; G05D 2109/10

(57) ABSTRACT

For at least partially autonomously driving the motor vehicle, a (second) large language model is interposed to a used artificial intelligence (formed as a first large language model). In this manner, it is possible, to pose queries to the user, who can actively change driving of the motor vehicle via the second large language model. Herein, it can be provided that the artificial intelligence (the first large language model) is exactly not retrained.

### BACKGROUND

### Technical Field

The disclosure relates to a method for at least partially autonomously and preferably fully autonomously driving a motor vehicle according to two different aspects of the disclosure as well as respectively to an associated motor vehicle.

### Description of the Related Art

Driving motor vehicles with the aid of artificial intelligence is known. In this context, the use of large language models increasingly gains in importance. With the term “large language model”, one denotes a program based on artificial intelligence, which is able to recognize and generate text, and in which so-called deep learning (training with training data among other things) is preferably used. Such large language models are employed in driving the vehicle in order that instructions for driving can be performed by voice input and explanations to the current driving mode can be returned as a response in text form. Further, the model can use a representation of the environment, which is provided by way of sensor data, as an input and output trajectories, which are to be driven, such that control commands to subordinated control devices for individual actuators or actuator groups of the motor vehicle can result from it.

Now, it can be desirable for an occupant of an at least partially autonomously and preferably fully autonomously driven motor vehicle to intervene in correcting manner. The article of Can Cui, et al.: “Receive, Reason, and React: Drive as You Say with Large Language Models in Autonomous Vehicles”, JOURNAL OF LATEX CLASS FILES, Vol. 14, No. 8, August 2015, as available in the Internet on Oct. 12, 2023 under https://arxiv.org/pdf/2310.08034.pdf, deals with this topic. Accordingly, a vehicle occupant can communicate to the vehicle, which is controlled by way of artificial intelligence, using a language model: “Drive more aggressively!” or conversely “Drive more conservatively!”, to change the driving behavior. Here, the point is a real-time adaptation of the driving style to voice inputs. Here, individual preferences are to be learned by the artificial intelligence in the long term such that a user profile can be created and it can be correspondingly driven in order that the user does not have to preset inputs over and over again.

From the article of Daocheng Fu, et al. with the title: “Drive Like a Human: Rethinking Autonomous Driving with Large Language Models”, prepublication, available on Jul. 14, 2023 in the Internet under https://arxiv.org/pdf/2307.07162.pdf, it is known that it can be examined using a language model how well artificial intelligence describes a system. In order to improve the performance of the model, an expert can hand out advice, which indicates how a human driver could handle a certain situation. Then, the model can learn from it in the long term.

Thus, it is assumed up to now that the artificial intelligence could not be sufficiently well trained and can be improved by training.

However, a complete plurality of situations cannot always be accounted for by training the artificial intelligence.

### BRIEF SUMMARY

Embodiments of the present disclosure provide an improved method for at least partially autonomously driving a motor vehicle and provide a corresponding motor vehicle, in which a user can give individual instructions and can thereby cause a situationally better response of a system employed for driving the motor vehicle.

According to a first aspect, a method for at least partially autonomously driving a motor vehicle comprises the steps:
providing a first large language model in the motor vehicle and providing a second large language model, the latter preferably also in the motor vehicle;
driving the motor vehicle by way of the first large language model;
receiving a first voice input by the second large language model; and
in at least one query iteration, outputting a query by the second large language model and receiving an input, preferably a further voice input, upon the query;
after a last query iteration, transferring an instruction output by the second large language model to the first large language model; and
driving the motor vehicle based on the instruction output by the first large language model.

The disclosure provides a division of tasks in that the second large language model enables the user to perform voice inputs, which do not have to be immediately implemented by the first large language model. By outputting a query, especially the second large language model can more accurately learn what the user wishes, and herein consider what the first large language model could implement (this optionally also after obtaining feedback to a preliminary query or pre-processing of sensor data), such that the instruction output then finally transferred to the first large language model is optimized for the first large language model.

Here, not solely a separation of tasks is present, but a new option of action is provided by the possibility of query, which ensures the desired flexibility in the operation.

According to an advantageous embodiment, a, preferably manual, input is received (in the next, optionally concluding step), by which it is confirmed that driving the motor vehicle by the first large language model sufficiently complies with the previous inputs in the opinion of an inputting person. Thus, in other words, a type of confirmation knob (or “button” on user interface like a touchscreen) can be pressed here. In this manner, it is communicated—wherein the second large language model does not have to be used anymore—to the first large language model that driving the motor vehicle can be continued as started.

Within the scope of a query iteration (in particular conclusively in the last query iteration), the knob or button can also allow the input of the confirmation to the second large language model, before the second large language model transfers the instruction output to the first large language model.

Alternatively, a, preferably manual, input can be received (this also via a knob or button on a user interface), by which the previous inputs (thus first voice input and following inputs upon the queries) are revoked, and a return to a driving style effected by the first large language model is caused before receiving the first voice input. (For this purpose, the first large language model can always immediately calculate two alternative trajectories, namely such one, which corresponds to its “normal” implementation, and such one, which corresponds to the performed input by the user; then, a short-term change between the trajectories is possible or at least facilitated).

According to a further advantageous embodiment of the disclosure, an automatic supervision is effected based on sensor data of sensors of the motor vehicle, whether the implementation of the instruction output by the first large language model sufficiently complies with the desire (by the first voice input and the following inputs upon query). This supervision by a “policy supervisor” can be associated with the fact that correcting instructions are optionally transferred to the first large language model (by this device) to better comply with the user's desire. Alternatively or additionally, it can be provided that a supervision is effected whether the implementation of the instruction output by the first large language model complies with further conditions, such as for instance provided regulations: For example, if the user wishes that the motor vehicle is to drive with a speed of 60 km/h, but the motor vehicle is in an area with speed limitation to 30 km/h, a correction is to be performed by the automatic supervision and a command (preferably in the form of a voice command) is to be given to the first large language model, which corrects it. Similarly, it can also be examined if planned trajectories are in conflict with further objects, which the user possibly has not considered with his command. In this case, it should brake and an alternative trajectory can be planned, which could be situated as close as possible to the trajectory desired by the user.

The motor vehicle according to the disclosure according to the first aspect includes a control device for implementing at least partially autonomous driving of the motor vehicle, wherein the control device includes a first large language model, which is configured to receive instructions in language form and to output control commands depending on the instructions for further devices of the motor vehicle. Further, the motor vehicle comprises a first interface, via which voice inputs can be received, and comprises a second interface to the control device, wherein the interfaces are coupled to a second large language model associated with the motor vehicle or can be coupled to a second large language model external to the motor vehicle, such that voice inputs received via the first interface can be converted into instructions to be transferred to the control device via the second interface.

The motor vehicle according to this aspect allows the interposition of the second large language model as in the method according to the disclosure to allow more flexible possibilities of input. In the variant that the second large language model is external to the motor vehicle, the coupling could be wirelessly effected (for instance via the Internet to an external server or also to a so-called Edge Node, a locally placed device for externally performing data processing for motor vehicles).

According to an advantageous embodiment of the motor vehicle, however, the second large language model is part thereof and configured to output a query via the first interface in at least one query iteration and to receive an input, preferably a further voice input, via the first interface, before an instruction to the control device is formulated (thus before an instruction is transferred to the control device via the second interface).

In this aspect, the motor vehicle more accurately implements the method according to the disclosure according to the first aspect.

According to a further advantageous embodiment of the motor vehicle, it includes a manual input device for performing a (confirming) input in a query iteration and/or for conforming that driving the motor vehicle by the first large language model sufficiently complies with the previous inputs in the opinion of an inputting person and/or for revoking the previous inputs to cause a return to a driving style effected by the first large language model before receiving the first voice input.

According to a further advantageous embodiment, the motor vehicle includes a supervising device (“policy supervisor”, as already mentioned above), to which data from sensors of the motor vehicle can be supplied, and which is configured to examine if an instruction transferred to the control device can be currently implemented (due to the driving regulations like speed limitations, restrictions on passing and the like, or else with regard to other objects on the road), and which is preferably further configured to transfer correcting instructions to the first large language model. The correcting instructions can even include that the commands of the user are completely ignored.

According to a second aspect of the disclosure, a method for at least partially autonomously driving a motor vehicle using a first large language model is provided, wherein the first large language model is a result of training with training data. This second aspect is preferably related to the first aspect, thus, the method according to the disclosure according to the second aspect is preferably also formed as a method according to the first aspect. In the method according to the second aspect, the motor vehicle is driven by way of the first large language model and an input is received, which transfers the instruction that a previous driving style according to driving by the first large language model is to be changed, wherein the instruction is implemented. According to the disclosure, after a lapse of time (with predetermined time lapse specification and/or depending on the received input) and/or after termination of a driving situation and/or due to a user input, the change according to the instruction is canceled, wherein the entirety of the used training data (“therein”) remains unchanged within the scope of the mentioned steps of the method.

According to the second aspect of the disclosure, thus, a learning operation is especially not continued in the first large language model. This has—and this preferably in connection with the interposition of the second large language model—the advantage that not every possibly not completely reasonable input of a user results in the fact that the thorough training of the first large language model is at least partially revoked or varied. In this manner, the first large language model can be more reliably permanently implemented and optionally again and again externally installed in newly updated manner in a motor vehicle, but without the use in exactly this motor vehicle being able to cause a permanent impairment of the result of the training.

The corresponding motor vehicle according to the second aspect is preferably also configured as the motor vehicle according to the first aspect, and it includes a control device for implementing at least partially autonomous driving of the motor vehicle, wherein the control device comprises a large language model, which is configured as a result of training with training data to receive instructions, preferably in language form, which cause a previous driving style according to driving by the (first) large language model to be changed and the instruction to be implemented, wherein the (first) large language model (“therein”, see above) remains unchanged with respect to the entirety of the training data according to the disclosure despite of the instruction and the implementation thereof.

For application cases or application situations, which can arise in the method and which are not explicitly described here, it can be provided that an error message and/or a request for inputting a user feedback are output and/or a default setting and/or a predetermined initial state are adjusted according to the method.

The control device for the motor vehicle also belongs to the disclosure. The control device can comprise a data processing device or a processor device, which is configured to perform an embodiment of the method according to the disclosure. Hereto, the processor device can comprise at least one microprocessor and/or at least one microcontroller and/or at least one FPGA (Field Programmable Gate Array) and/or at least one DSP (Digital Signal Processor). As the microprocessor, a CPU (Central Processing Unit), a GPU (Graphical Processing Unit) or an NPU (Neural Processing Unit) can in particular be respectively used. Furthermore, the processor device can comprise program code, which is configured, upon execution by the processor device, to perform the embodiment of the method according to the disclosure. The program code can be stored in a data memory of the processor device. The processor device can, e.g., be based on at least one circuit board and/or on at least one SoC (System on Chip).

Preferably, the motor vehicle according to the disclosure is configured as an automobile, in particular as a passenger car or truck, or as a passenger bus or motorcycle.

As a further solution, the disclosure also includes a computer-readable storage medium including program code, which, upon execution by a computer or a computer cluster, causes it to execute an embodiment of the method according to the disclosure. The storage medium can be provided at least partially as a non-volatile data memory (e.g., as a flash memory and/or as an SSD-solid state drive) and/or at least partially as a volatile data memory (e.g., as a RAM-random access memory). The storage medium can be arranged in the computer or computer cluster. However, the storage medium can for example also be operated as a so-called Appstore server and/or Cloud server in the Internet. By the computer or computer cluster, a processor circuit with at least one microprocessor can be provided, for example. The program code can be provided as a binary code and/or assembler code and/or as a source code of a programming language (e.g., C) and/or as a program script (e.g., Python).

The disclosure also includes the combinations of the features of the described embodiments. Thus, the disclosure also includes realizations, which each comprise a combination of the features of multiple of the described embodiments if the embodiments have not been described as mutually exclusive.

### BRIEF DESCRIPTION OF THE SEVERAL VIEWS OF THE DRAWINGS

In the following, embodiments of the disclosure are described.

FIG. 1 shows schematically components for driving a motor vehicle, which are used within the scope of the method according to the disclosure;

FIG. 2 shows a step sequence as it is passed within the scope of a first embodiment of the method according to the disclosure in a first response of the artificial intelligence; and

FIG. 3 shows a step sequence as it is passed within the scope of a second embodiment of the method according to the disclosure in a second response of the artificial intelligence.

### DETAILED DESCRIPTION

The execution examples explained in the figures are advantageous embodiments of the disclosure. In the execution examples, the described components of the embodiments each represent individual features of the disclosure to be considered independently of each other, which each also develop the disclosure independently of each other. Therefore, the disclosure also includes combinations of the features of the embodiments different from the illustrated ones. Furthermore, the described embodiments can also be supplemented by further ones of the already described features of the disclosure.

In the figures, identical reference characters each denote functionally identical elements.

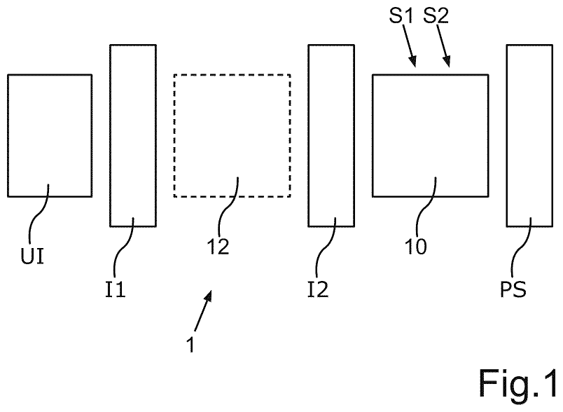

A motor vehicle denoted with 1 as a whole according to FIG. 1 includes a trained artificial intelligence as an actual control device 10, which can for example include one or more neural networks. It can be referred to as artificial intelligence for trained black-box driving (similarly: learned black-box driving, LBBD), wherein this artificial intelligence uses a representation of the environment of the motor vehicle 1 by way of sensors (in the drawing represented by the sensors S1 and S2) and further implements instructions in the form of voice input, wherein an explanation of the current driving mode can be output in text form and wherein the control device 10 can calculate two driving trajectories at the same time, namely, a currently traversed, which corresponds to the voice input, and one, which would be automatically selected without the voice input. In the present case, the control device is represented by a first large language model, to which reference is made below under the reference number 10; further components of the control device are here configured in a manner known per se. Further, there is a user interface UI, via which a user can perform voice inputs in that a voice recognition system is provided, wherein a haptic interface may be additionally given to confirm voice inputs after query (as explained below) and optionally to return into a normal mode.

Presently, it is of interest that the user interface UI is not—as inherently previously already used-immediately coupled to the first large language model 10, but that a second large language model 12 is interposed, this by way of a first interface (I1 for “interface 1”) to the user interface UI and a second interface (12 for “interface 2”) to the first large language model 10. The second large language model 12 is illustrated dashed because it does not necessarily have to be part of the motor vehicle 1, but in case of configuration of the interfaces I1 and I2 such that they also allow a wireless communication, it can also be arranged outside of the motor vehicle 1 and perform an external data processing.

Further, a so-called “policy supervisor” PS, thus a supervising device, which ensures that commands input via the user interface UI can be implemented in practical manner and corresponding to the regulations (for instance speed limitations, restrictions on overtaking, etc.), is additionally also provided.

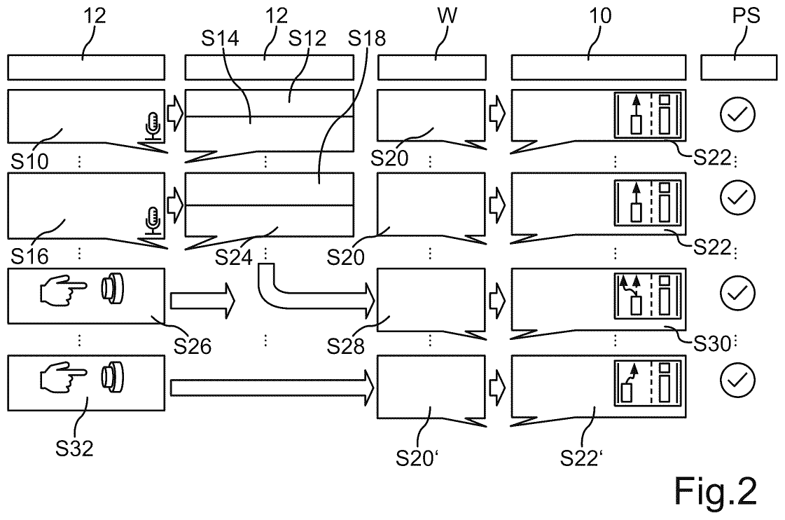

FIG. 2 shows a step sequence according to an embodiment of the method according to the disclosure, in which the first large language model responds in a more or less desired manner.

In step S10, the user performs a voice input, for instance in the manner of: “Keep a larger distance to the truck!”. The language model receives this input in step S12 and outputs the query in step S14: “To all trucks or only to that on the adjacent lane? Would an increase of the distance by 10% be all right?”

In step S16, the user can then respond via the user interface UI: “Yes, only trucks on the adjacent lane. 10% would be good.”

In the meantime, the first large language model 10 obtains the instruction as before (see in the column with instructions W) according to S20: “Drive in the normal mode!”, which is then implemented according to step S22. This occurs until a confirmation of the instruction has not yet been finally effected by the user via the user interface UI. The confirmation could be already given in step S16, such that the command could then be immediately implemented. In FIG. 2, a variant is shown, in which the second large language model 12 receives the instruction “Keep 10% distance to trucks on the adjacent lane!” according to step S18, and wherein it poses the query in step S24: “Is the command now to be implemented?”. In the meantime, driving in the normal mode according to the command S20 and step S22 is further maintained. Now, the user could simply say “Yes!” in case of voice input. In the variant advantageous here, however, the confirmation is effected in step S26 by pressing a knob or a button on a display like a touchscreen. In response to this action (confirmation by voice input or by pressing the knob in step S26 as illustrated in FIG. 2), the second large language model 12 causes the output of the actual instruction in step S28 to the first large language model: “Keep 10% distance to the trucks on the adjacent lane!”. Thereupon, the first large language model implements this command according to step S30; for reasons, which can be in the training, however, it can be that an additional distance of 50% of the previous distance instead of 10% of the previous distance is now kept. In other words, the instruction W is not perfectly implemented according to step S28. However, the policy supervision by the policy supervisor (PS) can respectively determine in steps S22 and S30 that the output command has been sufficiently accounted for, see the checkmark in the representation. After a period of time or in response to keeping the too large distance according to step S30, the user can give the input in step S32 that it is again returned to the normal mode, wherein the command can be given immediately, thus without detour via the second large language model 12, to the first large language model 10. This immediateness can preferably be ensured in that another possibility of input than the voice input is used, especially the shown knob or a button on a touchscreen. In response thereto, step S20′ is performed, thus, the instruction is again given to drive in the normal mode, and driving the motor vehicle in the normal mode according to S22′ is effected. This is then also confirmed by the policy supervisor PS.

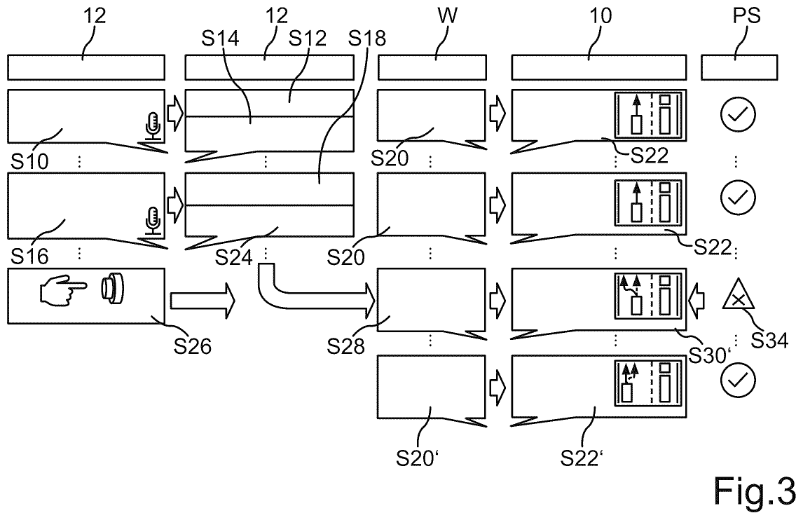

Now, it can be that the artificial intelligence is not sufficiently well trained to implement such commands. This is explained based on FIG. 3: Thus, if the step sequence according to steps S10, S12, S14, S16, S18 and S24 as well as S26 is as above such that the instruction according to step S28 is given: “Keep 10% distance to the trucks on the adjacent lane!”, then, it can occur in modification to step S30 that the first large language model 10 now wants to keep a distance of 100% more to the trucks on the adjacent lane (doubling of the distance instead of increase by 10%). However, the policy supervisor PS intervenes here and gives the indication in step S34 that the lane width could be exceeded such that driving on the adjacent lane thus is no longer possible at all. Accordingly, the policy supervisor PS now causes that it is again returned to driving in the normal mode after all such that the step S20′ and S22′ are initiated as in FIG. 2, analogously to the return due to the command in step S32.

The disclosure interposes the second large language model 12 between the user interface and the first large language model 10 and thus allows to the user to input commands, which are possibly not quite ideally implementable by the first large language model up to now. The second large language model 12 is to ensure that such commands are preferably formulated, thus converted into instructions W, this also by queries at the user, such that the first large language model 10 finally can often implement the commands after all. Here, it can in particular be reasonable to employ the policy supervisor PS in order to return to the normal driving mode in case that the first large language model 10 finally does not properly implement the command after all.

Overall, the examples show how a change of the policy (in at least partially autonomous and preferably autonomous driving) can be provided.

German patent application no. 102024114652.4, filed May 24, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for at least partially autonomously driving a motor vehicle, comprising:
providing a first large language model in the motor vehicle and a second large language model;
driving the motor vehicle by way of the first large language model;
receiving a first voice input by the second large language model; and
in at least one query iteration, outputting a query by the second large language model and receiving an input in response to the query;
after a last query iteration, transferring an instruction output by the second language large model to the first large language model; and
driving the motor vehicle based on an instruction output by the first large language model.

2. The method according to claim 1, wherein the second large language model is provided in the motor vehicle.

3. The method according to claim 1, wherein the input received in response to the query is a further voice input.

4. The method according to claim 1, further comprising:
receiving an input which confirms that the driving of the motor vehicle by the first large language model sufficiently complies with previous inputs in an opinion of an inputting person.

5. The method according to claim 4, wherein the input which confirms that the driving of the motor vehicle by the first large language model sufficiently complies with previous inputs is a manual input.

6. The method according to claim 1, further comprising:
receiving an input that revokes previous inputs, wherein a return to a driving style effected by the first large language model is caused before receiving the first voice input.

7. The method according to claim 6, wherein the input that revokes previous inputs is a manual input.

8. The method according to claim 1, further comprising:
effecting an automatic supervision, based on sensor data of sensors of the motor vehicle, that determines whether implementation of the instruction output by the first large language model sufficiently complies with certain conditions.

9. The method according to claim 8, wherein the automatic supervision determines whether implementation of the instruction output by the first large language model is in sufficient compliance with the inputs by an inputting person and/or is in compliance with practical circumstances.

10. The method according to claim 1, wherein the first large language model is trained with training data, and the method further comprises:
receiving an instruction that instructs a change of a previous driving style according to driving by the first large language model; and
implementing the instruction that instructs the change of the previous driving style according to driving by the first large language model,
wherein, after a lapse of time and/or after termination of a driving situation and/or due to a user input, the change instructed by the instruction is canceled and an entirety of the training data remains unchanged.

11. A motor vehicle, comprising:
a control device that, in operation, implements at least partially autonomous driving of the motor vehicle, wherein the control device includes a first large language model that, in operation, receives instructions in language form and, based on the instructions, outputs control commands for further devices of the motor vehicle;
a first interface that, in operation, receives voice inputs; and
a second interface to the control device,
wherein the first interface and the second interface, in operation, are coupled to a second large language model associated with the motor vehicle or external to the motor vehicle, such that the voice inputs received via the first interface are converted into instructions transferred to the control device via the second interface.

12. The motor vehicle according to claim 11, wherein the second large language model is a part of the motor vehicle, and wherein the second large language model, in operation, outputs a query via the first interface in at least one query iteration and receives an input in response to the query, via the first interface, before an instruction is transferred to the control device via the second interface.

13. The motor vehicle according to claim 12, wherein the input received in response to the query is one of the voice inputs.

14. The motor vehicle according to claim 10, further comprising:
a manual input device that, in operation, confirms or denies input in a query iteration and/or confirms that driving the motor vehicle by the first large language model sufficiently complies with previous inputs in an opinion of an inputting person and/or revokes the previous inputs and causes a return to a driving style effected by the first large language model before a first one of the voice inputs is received.

15. The motor vehicle according to claim 10, further comprising:
a supervising device that, in operation, receives data from sensors of the motor vehicle, and examines if an instruction transferred to the control device can be currently implemented.

16. The motor vehicle according to claim 15, wherein the supervising device, in operation, transfers correcting instructions to the first large language model.

17. The motor vehicle according to claim 11,
wherein the first large language model is trained with training data,
wherein the first large language model, in operation, receives an instruction that causes a previous driving style according to driving by the first large language model to be changed and implements the instruction, and
wherein the first large language model remains unchanged with respect to an entirety of the training data after implementation of the instruction.

18. The motor vehicle according to claim 17, wherein the instruction is in language form.
